(19) United States
(12) Patent Application Publication
(10) Pub. No.: US 2005/0130603 A1
(43) Pub. Date: Jun. 16, 2005

(54) Low noise transceiver

(76) Inventors: Kenneth George Maclean, Dallas, TX (US); Tobin Hagan, Dallas, TX (US); David John Baldwin, Allen, TX (US)

Correspondence Address: J. Dennis Moore;Texas Instruments Incorporated, PO Box 655474, M/S 3999, Dallas, TX, 75265, US

(21) Appl. No.: 10/733,146

(22) Filed: Dec. 11, 2003

(51) Int. Cl. H04B 1/38; H04B 1/44

(52) U.S. Cl. 455/78; 455/73

(57) ABSTRACT

The present invention relates generally to a low noise transceiver. The transceiver establishes substantially identical common mode voltages at first and second nodes. A receiver is coupled to the first node for receiving signals. The first and second nodes are connected during a first operating mode to provide a low impedance path for diverting received signals away from the first node and disconnected during a second operating mode to enable the receiver to detect signals received at the first node.

### TECHNICAL FIELD

The present invention relates generally to communications devices and more particularly to a low noise transceiver.

### BACKGROUND OF THE INVENTION

Wireless devices typically transmit and receive data through the air on high frequency electromagnetic waveforms. Encoding the data to be transmitted begins data transmission. This encoded data typically has a data rate of 100 kHz to 100 MHz and is used to modulate a high frequency carrier signal. The carrier signal is often in the 800 MHz to 10 GHz range. The modulated carrier signal is then applied to an antenna for broadcasting. Reception involves receiving a radio frequency (RF) signal on an antenna, and filtering undesired spectral components. The signal is demodulated, filtered again, and decoded.

Various types of communications devices exist for transmitting and receiving communications signals. Transceivers are a type of device that enables both transmission and reception at a single device, often times employing the same antenna. One class of transceivers operates in a half duplex mode in which the transceiver operates in one of a transmit mode or a receive mode. Other devices, usually more complex ones, can enable concurrent transmission and reception of signals. For many devices that operate in the half-duplex mode, a switch is utilized to facilitate the desired function, either transmission or reception of signals. Accordingly, transient signals can occur during transitions between the transmit mode and the receive mode. The transients can corrupt one or both of the transmitted signals or the received signals near the time of the transition.

### SUMMARY OF THE INVENTION

The present invention relates generally to a low noise transceiver. The transceiver establishes substantially identical common mode voltages at a pair of first and second nodes. A receiver also is coupled to the first node for detecting a received signal. A switch between the first and second nodes operates for connecting the nodes during a first operating mode (e.g., a transmit mode) and for disconnecting the nodes during a second operating mode (e.g., a receive mode). During the first operating mode, the first and second nodes form part of a low impedance path for diverting current away from the receiver. Additionally, since the common mode voltages exist at the first and second nodes, transients at the first node and at the receiver are mitigated as the transceiver transitions between the first and second operating modes.

Another aspect of the present invention provides a method for operating a transceiver. The method includes establishing a common mode voltage at a first node to which a receiver is coupled. The common mode voltage is also established at a second node. During a transmit operating mode, the first and second nodes are connected to define a low impedance path for propagating a transmission signal away from the first node. During a receive operating mode, the first and second nodes are disconnected to enable a signal provided at the first node to be detected by the receiver.

### BRIEF DESCRIPTION OF THE DRAWINGS

The foregoing and other aspects of the present invention will become apparent to those skilled in the art to which the present invention relates upon reading the following description with reference to the accompanying drawings.

FIG. 1 depicts a block diagram of a transceiver in accordance with an aspect of the present invention.

FIG. 2 depicts a block diagram of a transceiver in accordance with another aspect of the present invention.

FIG. 3 depicts a circuit diagram of a transceiver in accordance with an aspect of the present invention.

FIG. 4 is a flow diagram illustrating a methodology in accordance with an aspect of the present invention.

### DETAILED DESCRIPTION

The present invention relates generally to a communications device, such as a low noise transceiver. The transceiver establishes substantially identical common mode voltages at first and second nodes. A receiver also is coupled to the first node for receiving a signal. A switch interconnects the first and second nodes for connecting the nodes during a first operating mode (e.g., a transmit mode) and for disconnecting the nodes during a second operating mode (e.g., a receive mode). During the first operating mode, the first and second nodes form part of a low impedance path for diverting current away from the receiver. Additionally, since the common mode voltages exist at the first and second nodes, transients at the first node and at the receiver are mitigated as the transceiver transitions between the first and second operating modes.

FIG. 1 depicts an example of a system 10 that can be implemented in accordance with an aspect of the present invention. The system 10 includes a transmitter 12 coupled to an antenna 14 for transmitting desired data as electromagnetic waveforms modulated on a carrier. The antenna 14, for example, is configured to form a resonant circuit at the carrier frequency. The transmitter 12 receives an input signal indicative of the data to be modulated and transmitted via the antenna. For example, the input data can be transmitted as an amplitude shift keying (ASK) modulated signal, a frequency shift keying (FSK) modulated signal as well as other forms of modulation.

A receiver 16 is coupled to receive a signal at a node 20. The receiver 16 also is configured to provide a common mode voltage at the node 20. For example, the receiver 16 includes an amplifier configured to provide a desired common mode voltage at the node 20 based on a reference voltage signal (V_{REF}).

The antenna 14 is also coupled to the node 20 for receiving a modulated signal broadcast from an external source (not shown). The modulated signal received at the antenna 14 can be modulated to encode data using one of a number of possible formats. For example, the receiver 16 can be configured to receive a FSK modulated signal, an ASK modulated signal as well as other forms of modulation. The receiver 16 provides an output signal based on the modulated signal received by the antenna 14, such as during a receive mode of the system 10.

The system 10 also includes a switch 18 coupled between the first node 20 and a second node 22. An amplifier 24 provides a common mode voltage at the node 22, such as based on the reference voltage (V_{REF}). The common mode voltages at the node 20 and 22 can be substantially the same. The switch 18 operates to selectively connect and disconnect the respective nodes 20 and 22 based on a mode selection (MODE SEL) signal. The mode selection signal can be provided from a control system or other circuitry (not shown) to indicate an operating mode of the system 10.

A low impedance path, indicated at 26, is connected between the node 22 and electrical ground (or other low potential). For example, the low impedance path includes one or more components (e.g., including a capacitor) having a lower impedance relative to the impedance of the receiver 16. During the transmit mode, when the switch 18 is closed, the nodes 20 and 22 are coupled together for diverting transmission current from the node 20 and through low impedance path 26. The amplifier 24 can mitigate small DC bias currents by maintaining the desired common mode voltage at the node 22.

By way of further example, during the transmit mode, the mode selection signal operates the switch 18 to electrically couple the nodes 20 and 22. Thus, the transmission signal can travel from the transmitter 12 through the antenna 14 through the switch 18 through the low impedance path 26 and to ground. During a receive mode, the mode selection signal operates to decouple the nodes 20 and 22. As a result, a signal received by the antenna 14 is provided at the input of the receiver 16. The receiver 16 in turn provides a corresponding output signal indicative of the signal received by the antenna 14.

It will be appreciated that during transitions between the transmit mode and the receive mode, the DC voltage at the node 20 will remain substantially fixed due to the common mode voltage established at the nodes 20 and 22 by the receiver 16 and the amplifier 24, respectively. Because such common mode voltages are provided at the respective nodes 20 and 22 transient voltages or glitches at the node 20 are mitigated. This enables improved data reception by the receiver 16.

According to an aspect of the present invention, the transmitter 12, receiver 16, switch 18 and amplifier 24 can be implemented as part of a common integrated circuit 28. Additionally, while the low impedance path 26 is depicted as being external to the integrated circuit 28, it will be understood and appreciated that such path alternatively could be implemented within the IC 28.

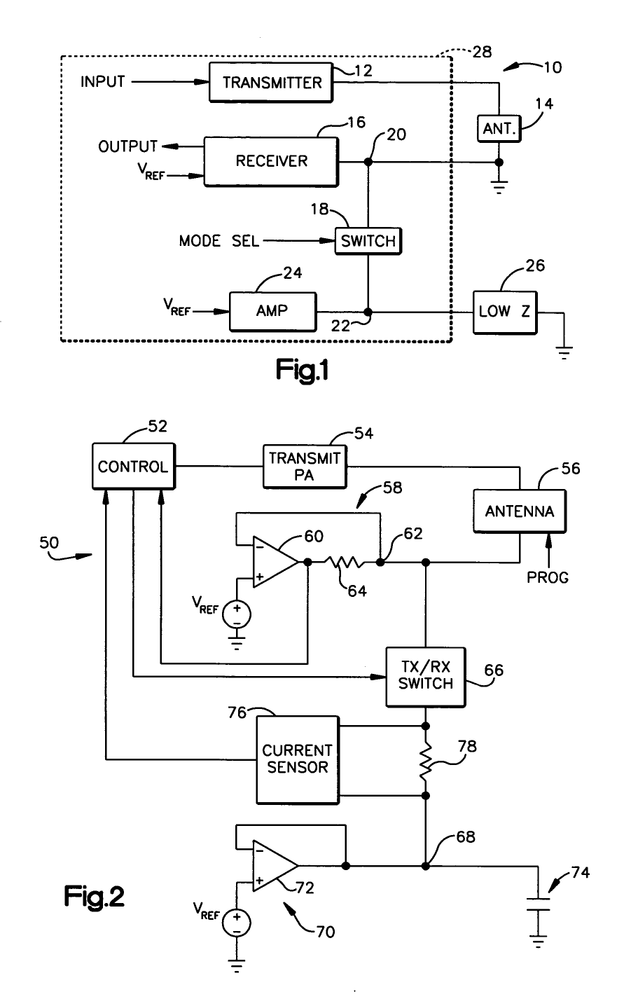

FIG. 2 depicts an example of a transceiver system 50 implemented in accordance with an aspect of the present invention. The system 50 includes a control block 52 that is operative to control operation of the system 50. The control block is coupled to a transmit power amplifier (PA) 54 that is operative to provide a modulated output signal to an associated antenna 56. The transmit PA 54 is configured to provide an output signal to the antenna 56 modulated at a desired carrier frequency. The antenna 56, for example, is a loop antenna configured to resonate at the carrier frequency provided by the transmit PA 54. The antenna 56 may have a variable resonant frequency, which can be set by a program signal (PROG) to configure one or more components to a desired impedance value.

The system 50 also includes a receiver 58 coupled to the antenna 56. That is, the antenna is connected between the transmit PA 54 and the receiver 58. The receiver 58 includes an operational amplifier (op-amp) 60 that receives a reference voltage (V_{REF}) signal at a non-inverting input. An inverting input of the op-amp 60 is coupled to an input node 62 of the receiver 58, which is coupled to the antenna 56. An output of the op-amp 60 is coupled to the control block 52 for providing an indication of a signal detected by the receiver 58.

The receiver 58 also includes a resistor 64 coupled between the output of the op-amp 60 and a node 62, although other types of components could also be utilized. The node 62 is connected with an inverting input of the op-amp 60 to form a negative feedback loop. The resistor 64 is located within the feedback loop of the receiver 58. As a result, the output of the op-amp 60 can swing over a desired voltage range in response to signals received at the antenna 56 while the desired common mode voltage (e.g., V_{REF}) is maintained at the node 62. The corresponding signal at the output of the op-amp 60 is provided to the control block 52.

A transmit/receive (TX/RX) switch 66 is coupled between the node 62 and an associated node 68. The switch 66 operates based on a mode signal provided by the control block 52. For example, the switch 66 electrically connects the respective nodes 62 and 68 during a transmit mode and decouples the respective nodes during a receive mode. Thus, during the receive mode, a signal received at the antenna 56 is provided to the receiver 58. In this way, the receive signal provided to the control block by the op-amp 60 corresponds to the signal received at the antenna 56. During the transmit mode, the transmit current can be diverted through the switch 66 and away from the receiver 58.

Another amplifier 70 is coupled to provide a desired common mode voltage at the node 68. In particular, the amplifier 70 includes an op-amp 72 that receives a DC reference voltage V_{REF} at a non-inverting input of the op-amp. An inverting input of the op-amp 72 is coupled to the output of the op-amp such that the desired common mode voltage (e.g., V_{REF}) is provided at the node 68. A low impedance path is also connected at the node 68, which in this example is implemented as a capacitor 74.

In the example of FIG. 2, a current sensor 76 is coupled across a current sense resistor 78 connected between the switch 66 and the node 68. The current sensor 76 provides a current sense signal to the control block 52 indicative of current flowing through the resistor 78 during the transmit mode. The current sense resistor 78 can be implemented, for example, as a low resistance (e.g., about 1 Ω) so that it has a substantially insignificant impact on the impedance of the path between the antenna 56 and the low impedance path 74.

The control block 52 can employ the current sense signal from the current sensor 76 to control the power of the transmit PA 54 during the transmit mode. For example, during the transmit mode, the control block 52 provides a mode selection signal to operate the switch 66 to a closed condition. The transmission signal provided by the transmit PA 54 is provided to the antenna 56, encoding desired data at the resonant frequency. The antenna 56 broadcasts the transmission signal to free space as a corresponding wireless signal. The transmission signal (e.g., electrical current) also propagates through the switch 66, through the current sense resistor 78 and to the low impedance path 74. The amount of current flowing through the current sense resistor 78 can be utilized by the control block 52 as feedback to adjust the transmit power. During the transmit mode, an insignificant amount of the transmission current may be provided to the receiver 58 since most current is diverted through the switch 66 and to the low impedance path 74.

When the control block 52 provides the mode selection signal to open the switch 66 for entering the receive mode, a signal received at the antenna 56 is provided to the input of the receiver 58. Since the op-amp 60 maintains the input node 62 at the desired common mode voltage V_{REF}, the output of the op-amp 60 will vary as a function of the signal received by the antenna 56.

It will be appreciated that when the switch 66 is opened (e.g., a transition from the transmit mode to the receive mode), transients (or glitches) at the input node 62 are mitigated since the nodes 62 and 68 are both maintained at the desired common mode voltage V_{REF}. Similarly, when changing from the receive mode to the transmit mode, glitches are also mitigated due to the common mode voltage at the nodes 62 and 68.

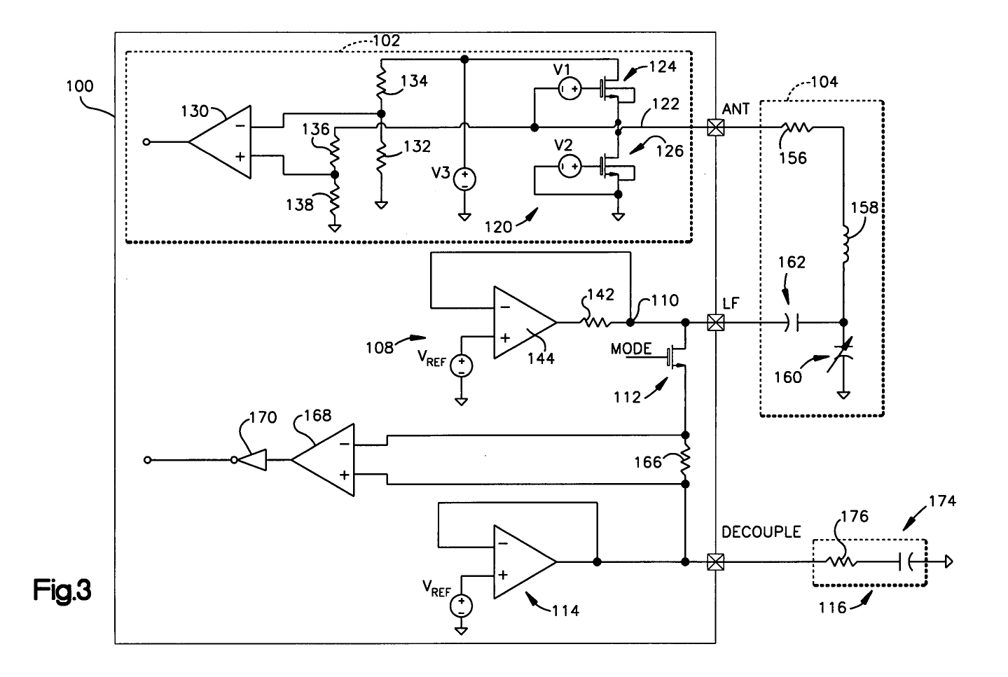

FIG. 3 depicts an example of a transceiver system 100 that can be implemented in accordance with an aspect of the present invention. In this example, the transceiver system 100 is illustrated as an integrated circuit. The transceiver system 100 includes a transmitter portion 102 that is coupled to an antenna 104 through an antenna pin (ANT). The antenna 104, for example, is a loop antenna that defines a resonant circuit. The transceiver system 100 also includes a receiver portion 108 that is coupled to the antenna 104 through a low frequency (LF) pin of the IC incorporating the transceiver system. The LF pin thus corresponds to an input node 110 of the receiver portion 108 for receiving a signal received by the antenna. The input node 110 is coupled to a DECOUPLE pin through a switch device 112. The switch device 112, for example, is a transistor (e.g., metal oxide field effect transistor) that operates to selectively couple the LF pin with the DECOUPLE pin based on a mode selection signal provided by control circuitry (not shown).

The receiver portion 108 is configured to maintain a desired common mode voltage at the node 110 and the LF pin (the LF pin is essentially the same as the node 110). The transceiver system 100 also includes another amplifier 114 coupled to the DECOUPLE pin to maintain the desired common mode voltage at the DECOUPLE pin. Circuitry 116 is connected to the DECOUPLE pin. The circuitry 116 provides a low impedance path for sinking transmission current when the switch device 112 is closed.

Turning to the contents of the transmitter portion 102, a power amplifier 120 (e.g., a class D amplifier) is coupled to provide corresponding output signal at a desired carrier frequency to encode desired data. The amplifier 120 provides its output at a node 122, which corresponds to the ANT pin. The transmitter portion 102 is configured to provide a large output voltage (e.g., about 20 V to about 50 V peak-peak) for encoding data to be transmitted over the antenna 104. In the example of FIG. 3, the amplifier 120 includes a first transistor 124 connected between the output node 122 and a peak voltage V3. The voltage V3, for example, can be fixed to a voltage in the range from about 20 V to about 50 V. The voltage V3 thus establishes a maximum peak-to-peak voltage (Vₚ₋ₚ) for the amplifier 120. Those skilled in the art will appreciate that the particular voltage V3 can depend, among other things, on the desired transmission range and the antenna configuration.

A desired oscillating or pulse-width-modulated voltage signal V1 is provided at the gate of the transistor 124. The signal V1 is provide by control circuitry (not shown). A second transistor 126 is connected between the output node 122 and ground. The transistor 126 is controlled by an oscillating or pulse-width-modulated voltage signal V2. Thus, the signals V1 and V2 control the respective transistors 124 and 126 so that a corresponding square wave is provided at 122 and the ANT pin.

Each of the signals V1 and V2 can be provided by control circuitry (not shown) for encoding output data at the desired carrier frequency. The antenna 104 can be tuned to resonate at the carrier. As a result, the antenna 104 operates as a resonant circuit that converts the output square wave at 122 to a corresponding sine wave for broadcasting as electromagnetic waveforms by the antenna. For example, the transmitter portion 102 can provide ASK modulated data by selectively controlling the V1 and V2 at the gates of the respective transistors 124 and 126. The antenna 104, for example, transmits an electromagnetic waveform for receipt by one or more associated receivers, transceivers or transponders.

The transmitter portion 102 also includes a comparator 130 that is coupled to compare the respective voltages provided by the transistors 124 and 126. One input of the comparator 130 is coupled to a voltage divider formed of resistors 132 and 134 coupled in series between a drain of the transistor 124 and ground. Another input of the comparator 130 is coupled to a voltage divider formed of resistors 136 and 138. This voltage divider 136, 138 is coupled between ground and the output node 122, which corresponds to the voltage across the other transistor 126. The comparator 130 in turn provides a corresponding output signal corresponding to the comparison of the sensed voltages. The comparator output signal can be utilized (e.g., by control circuitry) to control the transmitter portion 102.

The receiver portion 108 includes a resistor 142 connected between an output of an op-amp 144 and the node 110 at the input of the receiver portion. The inverting input of the op-amp 144 is also connected to the input 110 to provide desired negative feedback. The node 110 is maintained at the desired common mode voltage based on a reference voltage V_{REF} provided at the non-inverting input. Since the resistor 142 is within the feedback loop of the amplifier, the output node 110 will remain at the common mode voltage while the output of the op-amp 144 varies as a function of the signal received by the antenna 104. For example, the signal received at the antenna 104 can be a FSK key modulated signal provided by an external transmitter or transponder.

It will be understood and appreciated that the receiver portion 108 allows for large transmission signals at the ANT pin (e.g., about 20-50 Vₚ₋ₚ) while maintaining the signals at the LF and DECOUPLE pins comparatively small (e.g., about less than about 5 Vₚ₋ₚ). Additionally, it will further be appreciated that the configuration depicted herein enables the receiver portion 108 to have a large dynamic range. That is, while the input node 110 is maintained at the desired common mode voltage (e.g., corresponding to V_{REF} 2.5 volts), the output of the op-amp 144 can swing between 0 and about two times the V_{REF} (e.g., about 5 volts) based on the signal received by the antenna 104.

The antenna 104 is depicted as including a resistor 156 in series with an inductor 158. A capacitor 160 is coupled between the inductor 158 and electrical ground. Another capacitor 162 is coupled between the LF pin and a node between the inductor 158 and capacitor 160. The capacitor 160, for example, corresponds to a trim capacitor that can be set to a desired capacitance so that the antenna 104 defines a resonant circuit that can resonate at a desired frequency, namely, at the carrier provided by the transmitter portion 102.

By way of example, the resistor 156 can have a resistance of about 49 Ω and the inductor 158 can have an inductance of about 466 μH±10%. The capacitor 162, for example, can be at about 3 nF and the trim capacitor 160 can be set to about 3.37 nF to achieve resonance at approximately 127 KHz. For such an antenna configuration, the capacitance of the circuitry 116 that defines the low impedance path can be set to about 1 μF, which contributes about 0.3% of the series capacitance with the capacitor 162 during the transmit mode. Those skilled in the art will appreciate that other values can be utilized to achieve resonance at other frequencies.

During the transmit mode, the transmitter portion 102 provides transmission current to the antenna 104. Since the switch device 112 is closed in this operating mode, the transmission current is diverted away from the receiver portion 108 to the circuitry 116 that defines the low impedance path. The transmission current can also be sensed through a current sense resistor 166 (e.g., about 1 Ω). For instance, a comparator 168 is coupled across the current sense resistor 166 to provide a corresponding output signal indicative of the transmission current. The output of the comparator 168 can be utilized to further control the transmitter portion 102 during the transmit mode to maintain a desired power level for the transmission. For example, associated control circuitry (not shown) can be utilized to control the pulse-width-modulated input signals at V1 and V2 based on the output signal provided by the comparator 168. In this example, the output of the comparator 168 is provided through a buffer 170.

As mentioned above, the transmission current through the current sense resistor 166 is also provided to the circuitry 116 that defines a low impedance path. In this example, the circuitry 116 includes a capacitor 174 (e.g., about 1 μF) that has an associated series resistance 176 (e.g., about 40-100 mΩ). By selecting the capacitor 174 to have a substantially greater capacitance than the series capacitance provided by the capacitor 162 (e.g., about 3 nF), while in the transmit mode, the capacitor 162 dominates. As a result, the circuitry 116 provides a desired low impedance path for the transmission current provided at the resonant frequency of the antenna 104. Additionally during the transmit mode, the amplifier 114 can mitigate DC bias currents by maintaining the desired common mode voltage at the DECOUPLE pin.

It is to be appreciated that when the transistor 112 is activated to disconnect the LF and DECOUPLE pins (corresponding to a transition from the transmit mode to the receive mode), transients or glitches at the LF pin (and node 110) are mitigated. This is because the receiver portion 108 and the amplifier 114 maintain desired common mode voltages at the respective LF and DECOUPLE pins. Transients are also mitigated for transitions from the receive mode to the transmit mode when the LF and DECOUPLE pins are connected through activation of the switch device 112. Since the configuration in FIG. 3 substantially prevents spurious signals from being injected into the receiver portion, reception can be improved relative to other transceiver designs.

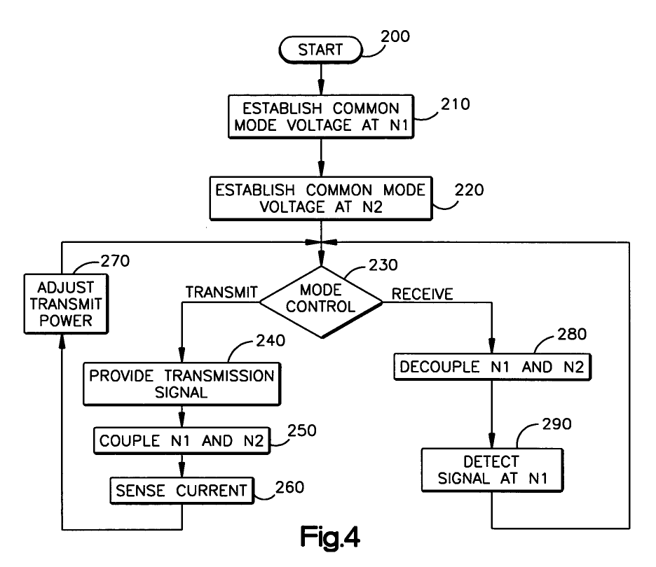

In view of the foregoing structural and functional features described above, certain methodologies that can be implemented will be better appreciated with reference to FIG. 4. While, for purposes of simplicity of explanation, the method of FIG. 4 is shown and described as being implemented serially, it is to be understood and appreciated that the illustrated actions, in other embodiments, may occur in different orders and/or concurrently with other actions. Moreover, not all illustrated features may be required to implement a method according to an aspect of the present invention. It is to be further understood that the following methodology can be implemented in hardware, such as one or more integrated circuits, software, or any combination thereof.

FIG. 4 depicts a flow diagram of an example method that can be implemented in accordance with an aspect of the present invention. The method begins at 200 such as in connection with providing power to circuitry (e.g., an integrated circuit or circuit board) utilized to implement the method. At 210, a common mode voltage is established at node N1. Node N1, for example corresponds to a connection to an associated antenna, such as for receiving an input signal from one or more external sources. The input signal, for example, can be an FSK modulated signal, although other types of modulation also can be utilized. At 220, a common mode voltage is established at node N2. The node N2, for example, corresponds to a DECOUPLE node to which a low impedance path is connected. The low impedance path provides a path during a transmit mode for diverting electrical current away from a receiver coupled to the node N1.

At 230, mode control is implemented to decide whether the method is in a transmit mode or a receive mode. For example, the mode control is implemented by a control system according to a predefined control algorithm for the circuitry implementing the method. In the transmit mode (TRANSMIT), the methodology proceeds from 230 to 240. At 240, a transmission signal is provided to an antenna at a desired carrier frequency. For example, the transmission signal is provided to an output pin of an integrated circuit to which an antenna is coupled. The antenna can be a loop antenna configured to broadcast electromagnetic waveforms at the carrier frequency based on the transmit signal provided at 240. At 250, nodes N1 and N2 are coupled together. This creates a connection to a low impedance path connected at node N2 so that the transmission signal can be diverted away from N1 as well as away from a receiver coupled at node N1.

At 260, the transmission current can be sensed. The sensed current can then be utilized to adjust transmit power (as needed) at 270. From 270, the methodology returns to 230 in which the methodology can remain in the transmit mode or switch to a receive mode, such as based on a mode control signal.

If the mode control at 230 causes the method to enter the receive mode (RECEIVE), the method proceeds to 280. In the receive mode, at 280, nodes N1 and N2 are decoupled. This results in disconnecting the low impedance path from the circuit as well as forcing electrical current propagated by the antenna (e.g., corresponding to a signal received by the antenna) to the receiver coupled at node N1.

For example, electromagnetic waveforms can be received at an antenna and, in turn, converted to an electrical signal and provided to the receiver. Because the nodes N1 and N2 are decoupled during the receive mode, electrical current corresponding to the received signal is provided to an input of the receiver. At 290, the signal received at the node N1 is detected by the receiver, which can then be processed. The signal can be detected, for example, by adjusting an output of an associated amplifier of the receiver based on electrical current provided by the antenna so as to maintain the desired common mode voltage at node N1. Since the common mode voltage is maintained at the node N1, variations in the output of the receiver amplifier represents the received signal, which can be processed in a desired manner. The received signal, for example, can correspond to an FSK modulated signal, although other types of modulation can also be utilized.

From 290, the methodology returns to 230 in which the method can either remain in the receive mode or switch back to the transmit mode. It can be appreciated that as the method switches between the receive mode and the transmit mode, glitches at node N1 (e.g., an input of the receiver) are mitigated. This is because the common mode voltages established at 210 and 220 are maintained throughout the method. As a result, a more accurate indication of the received signal can be provided at the input of the receiver thereby improving reception of the transceiver. Those skilled in the art will understand and appreciate various circuit configurations, including analog and/or digital circuitry, that can be utilized to implement the method described above.

What has been described above includes examples and implementations of the present invention. Because it is not possible to describe every conceivable combination of components, circuitry or methodologies for purposes of describing the present invention, one of ordinary skill in the art will recognize that many further combinations and permutations of the present invention are possible. Accordingly, the present invention is intended to embrace all such alterations, modifications and variations that fall within the spirit and scope of the appended claims.

1. A transceiver comprising:
a receiver coupled to receive a signal at a first node, the receiver establishing a desired common mode voltage at the first node;
circuitry coupled to establish the desired common mode voltage at a second node; and
the first and second nodes defining at least a portion of a low impedance path during a first operating mode for diverting a signal received at the first node away from the receiver, and the first and second nodes defining a high impedance path during a second operating mode for enabling the signal received at the first node to be provided to the receiver.

2. The transceiver of claim 1, further comprising a switch device connected between the first and second nodes, the switch device operating to connect the first and second node to provide the low impedance path during the first operating mode, and the switch operating to disconnect the first and second node to define the high impedance path during the second operating mode.

3. The transceiver of claim 2, further comprising a controller coupled to operate the switch based on a selected one of the first and second operating modes.

4. The transceiver of claim 1, the receiver further comprising:
an amplifier having an output; and
a resistor coupled between the first node and the output of the amplifier.

5. The transceiver of claim 4, further comprising a feedback path coupled between an input of the amplifier and the first node to enable the desired common mode voltage to be provided at the first node, the output of the amplifier varying as a function of the signal received at the first node during the second operating mode.

6. The transceiver of claim 5, the circuitry further comprising an amplifier having an output that defines the second node and a feedback path between the second node and an input of the amplifier of the circuitry to establish the desired common mode voltage at the second node.

7. The transceiver of claim 1, further comprising a transmitter coupled to provide a transmitter output signal at a third node.

8. The transceiver of claim 7, further comprising an antenna connected between the first and third nodes.

9. The transceiver of claim 8, the antenna being configured to define a resonant circuit having a resonant frequency corresponding to the frequency of the transmitter output signal.

10. An integrated circuit comprising the transceiver of claim 1.

11. A communications apparatus comprising:
a receiver coupled to receive a signal at a first node, the receiver establishing a desired common mode voltage at the first node;
an amplifier coupled to establish the desired common mode voltage at a second node;
a switch device connected between the first and second nodes, the switch device operating to connect the first and second nodes to provide a low impedance path during a first operating mode, and the switch operating to disconnect the first and second node during a second operating mode;
a transmitter that provides a transmitter output signal at a third node having a desired carrier frequency;
an antenna coupled between the first and third nodes; and
a low impedance path coupled to the second node for diverting current away from the first node during the first operating mode.

12. The apparatus of claim 1, the receiver further comprising:
an amplifier having an output;
a resistor coupled between the first node and the output of the receiver amplifier; and
a feedback path coupled between an input of the receiver amplifier and the first node to enable the desired common mode voltage to be provided at the first node, the output of the receiver amplifier changing as a function of a signal received by the antenna during the second operating mode.

13. The apparatus of claim 1, at least the receiver, the amplifier, the transmitter and the switch comprising an integrated circuit.

14. A transceiver comprising:
means for receiving a signal at a first node and for maintaining a common mode voltage at the first node;
means for maintaining a common mode voltage at a second node;
means for connecting the first and second nodes during a first operating mode and for disconnecting the first and second nodes during a second operating mode.

15. The transceiver of claim 14, further comprising means for diverting electrical current away from the first node during the first operating mode.

16. The transceiver of claim 15, the means for diverting electrical current comprising a low impedance path coupled to the second node.

17. The transceiver of claim 14, further comprising
means for providing a transmission signal at a third node; and
antenna means for broadcasting the transmission signal during the first operating mode and for receiving signals from free space during the second operating mode, the antenna means being coupled between first node and the second node.

18. A method to operate a transceiver, the method comprising:
establishing a common mode voltage at a first node to which a receiver is coupled;
establishing the common mode voltage at a second node;
connecting the first and second nodes during a transmit operating mode to provide a low impedance path for propagating a transmission signal away from the first node; and
disconnecting the first and second nodes during a receive operating mode to enable a signal provided at the first node to be detected by the receiver.

19. The method of claim 18, during the transmit operating mode, further comprising providing a transmission signal to a third node, an antenna being coupled between the first and third nodes so that the transmission signal is provided to the low impedance path and away from the first node.

20. The method of claim 19, further comprising sensing the transmission signal and adjusting transmit power of the transmission signal based on the sensed transmission signal.

21. The method of claim 18, during the receive operating mode, further comprising detecting a signal received at an antenna coupled to the first node.

22. The method of claim 21, the detecting of the signal further comprising detecting the signal by varying an output signal provided at an output of an amplifier as a function the signal received at the antenna while maintaining the common mode voltage at the first node, the output of the amplifier being connected to the first node through at least one impedance element.
